(19) United States
(12) Patent Application Publication
(10) Pub. No.: US 2025/0310731 A1
(43) Pub. Date: Oct. 2, 2025

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Jinhua WU, Beijing (CN)

(21) Appl. No.: 18/864,442

(22) PCT Filed: May 13, 2022
(86) PCT No.: PCT/CN2022/092600

§ 371 Date: Nov. 8, 2024

(51) Int. Cl. H04W 4/38; H04W 8/22; H04W 76/20

(52) U.S. Cl. CPC H04W 4/38; H04W 8/22; H04W 76/20

(57) ABSTRACT

A method for processing information is performed by an Access and Mobility Management Function (AMF), includes: receiving request information sent by a user equipment (UE), wherein the request information is configured to request service information of a sensing application function; and sending, based on the request information, the service information of the sensing application function to the UE, wherein the service information is at least configured to indicate an address of the sensing application function.

### CROSS-REFERENCE

The present application is a U.S. National Stage of International Application No. PCT/CN2022/092600, filed on May 13, 2022, the entire content of which is incorporated herein by reference.

### TECHNICAL FIELD

The present disclosure relates to but is not limited to a field of communication technology, and more particularly, to a method and an apparatus for processing information, a communication device, and a storage medium.

### BACKGROUND

In cellular mobile communication technology, the mobile communication network may adopt an integrated communication perception (communication sensing) scheme to integrate communication and sensing functions, such that the communication system has both communication and sensing functions. While sensing information is transmitted in a wireless channel, the physical characteristics of the surrounding environment may be sensed by actively recognizing and analyzing the characteristics of the channel.

The integrated sensing and communication in the cellular mobile communication system implies that the sensing capability is provided by the wireless communication system and infrastructure used for communication, and that the sensing information may be derived from RF-based and/or non-RF-based sensors. The communication sensing relates to scenarios where communication-assisted sensing is used, e.g., where 5G communication system provides the sensing service or sensing-assisted communication; e.g., when the communication channel and environmentally-associated sensing information is used to improve the communication service of the 5G system itself; e.g., the sensing information may be used to assist in radio resource management, interference mitigation, beam management, mobility, and the like.

### SUMMARY

Embodiments of the present disclosure disclose a method and an apparatus for processing information, a communication device, and a storage medium.

According to a first aspect of the present disclosure, a method for processing information is provided, the method is performed by an Access and Mobility Management Function (AMF), and includes:

receiving request information sent by a user equipment (UE), where the request information is configured to request service information of a sensing application function; and

sending, based on the request information, the service information of the sensing application function to the UE, where the service information is at least configured to indicate an address of the sensing application function.

According to a second aspect of the present disclosure, a method for processing information is provided, the method is performed by a Session Management Function (SMF), and includes:

receiving request information sent by an Access and Mobility Management Function AMF, where the request information is configured to request service information of a sensing application function; the request information is sent by a user equipment UE to the AMF, and the service information is at least configured to indicate an address of the sensing application function; and

sending, in response to the request information, the service information of the sensing application function to the AMF, where the service information is sent by the AMF to the UE.

According to a third aspect of the present disclosure, a method for processing information is provided, the method is executed by a user equipment UE, and includes:

sending request information to an Access and Mobility Management Function AMF, where the request information is configured to request service information of a sensing application function;

receiving the service information of the sensing application function sent, based on the request information, by the AMF, where the service information is at least configured to indicate an address of the sensing application function.

According to a fourth aspect of the present disclosure, a communication device is provided and includes:

a processor;

a memory for storing executable instructions of the processor;

the processor is configured to implement the method for processing the information described in the first aspect, the second aspect, or the third aspect when running the executable instructions.

It should be understood that the above general description and the following detailed description are only exemplary and explanatory, and do not limit the present disclosure.

### BRIEF DESCRIPTION OF THE DRAWINGS

FIG. 1 is a schematic diagram of a structure of a wireless communication system according to an embodiment.

FIG. 2 is a flowchart of a method for processing information according to an embodiment.

FIG. 3 is a flowchart of a method for processing information according to an embodiment.

FIG. 4 is a flowchart of a method for processing information according to an embodiment.

FIG. 5 is a flowchart of a method for processing information according to an embodiment.

FIG. 6 is a flowchart of a method for processing information according to an embodiment.

FIG. 7 is a schematic diagram of a structure of a communication system according to an embodiment.

FIG. 8 is a schematic diagram of information processing interaction according to an embodiment.

FIG. 9 is a schematic diagram of information processing interaction according to an embodiment.

FIG. 10 is a block diagram of an apparatus for processing information according to an embodiment.

FIG. 11 is a block diagram of an apparatus for processing information according to an embodiment.

FIG. 12 is a block diagram of an apparatus for processing information according to an embodiment.

FIG. 13 is a block diagram of a UE according to an embodiment.

FIG. 14 is a block diagram of a base station according to an embodiment.

### DETAILED DESCRIPTION

Here, example embodiments will be described in detail, instances of which are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of apparatus, devices, and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms, unless the context clearly indicates other meanings. It should also be understood that the term “and/or” used herein refers to and includes any or all possible combinations of one or more associated items as listed.

It should be understood that although the terms first, second, third, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to that”.

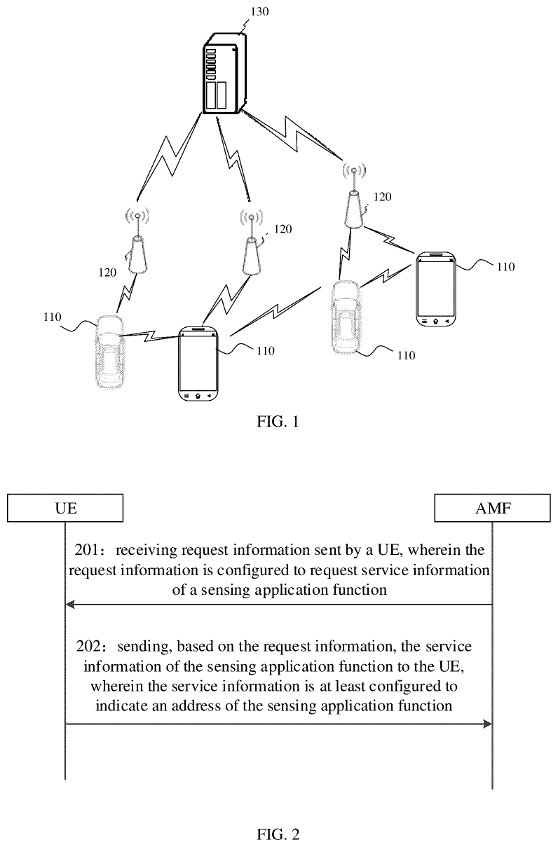

Reference may be made to FIG. 1, which shows a schematic structural diagram of a wireless communication system provided by an embodiment of the present disclosure. As shown in FIG. 1, the wireless communication system is a communication system based on cellular mobile communication technology, and the wireless communication system may include a number of user equipment 110 and a number of base stations 120.

The user equipment 110 may be a device that provides voice and/or data connectivity to a user. The user equipment 110 may communicate with one or more core networks via a radio access network (RAN). The user equipment 110 may be an Internet of Things user equipment, such as a sensor device, a mobile phone (also known as a “cellular” phone), and a computer with an Internet of Things user equipment. For example, the user equipment may be a fixed, portable, pocket-sized, handheld, computer-built-in or vehicle-mounted device. For example, it may be a station (STA), subscriber unit, subscriber station, mobile station, mobile, remote station, access point, remote terminal, access terminal, user terminal, user agent, user device, or user equipment. In some embodiments, the user equipment 110 may also be a device of an unmanned aerial vehicle. In some embodiments, the user equipment 110 may also be a vehicle-mounted device, such as a driving computer with wireless communication function, or a wireless user device connected to an external driving computer. In some embodiments, the user equipment 110 may also be a roadside device, such as a street lamp, a signal lamp, or other roadside device with wireless communication function.

The base station 120 may be a network-side device in a wireless communication system. The wireless communication system may be a 4th generation mobile communication (4G) system, also known as a long term evolution (LTE) system. In some embodiments, the wireless communication system may be a 5G system, also known as a new air interface system or a 5G NR system. In some embodiments, the wireless communication system may be a next generation system of the 5G system. The access network in the 5G system may be referred to as New Generation-Radio Access Network (NG-RAN).

The base station 120 may be an evolved base station (eNB) used in a 4G system. In some embodiments, the base station 120 may also be a base station (gNB) using a centralized distributed architecture in a 5G system. When the base station 120 uses a centralized distributed architecture, it generally includes a centralized unit (CU) and at least two distributed units (DUs). The centralized unit is provided with a protocol stack of a packet data convergence protocol (PDCP) layer, a radio link control (RLC) layer, and a media access control (MAC) layer. The distributed unit is provided with a physical (PHY) layer protocol stack. The specific implementations of the base station 120 are not limited in the embodiments of the present disclosure.

A wireless connection may be established between the base station 120 and the user equipment 110 through a wireless air interface. In different implementations, the wireless air interface is a wireless air interface based on the fourth generation mobile communication network technology (4G) standard. In some embodiments, the wireless air interface is a wireless air interface based on the fifth generation mobile communication network technology (5G) standard. For example, the wireless air interface is a new air interface. In some embodiments, the wireless air interface may also be a wireless air interface based on the next generation mobile communication network technology standard of 5G.

In some embodiments, an End to End (E2E) connection may also be established between the user equipment 110, for example, vehicle to vehicle (V2V) communication, vehicle to infrastructure (V2I) communication, and vehicle to pedestrian (V2P) communication in vehicle to everything (V2X) communication.

Here, the user equipment may be considered as the terminal device in the following embodiments.

In some embodiments, the wireless communication system may also include a network management device 130.

Several base stations 120 are respectively connected to the network management device 130. The network management device 130 may be a core network device in the wireless communication system. For example, the network management device 130 may be a mobility management entity (MME) in the evolved packet core (EPC). In some embodiments, the network management device may also be other core network devices, such as a Serving Gate Way (SGW), a Public Data Network Gate Way (PGW), a Policy and Charging Rules Function (PCRF), or a Home Subscriber Server (HSS). The embodiments of the present disclosure do not limit the implementations of the network management device 130.

In order to facilitate the understanding of those skilled in the art, the embodiments of the present disclosure list various implementations to clearly illustrate the technical solution of the embodiments of the present disclosure. It shall be noted, those skilled in the art may understand that multiple embodiments provided in the embodiments of the present disclosure may be executed separately, or executed together with the methods in other embodiments of the embodiments of the present disclosure, or executed separately or in combination with some methods in other related technologies. The embodiments of the present disclosure are not limited in this regard.

Mobile operators may play an important role in providing customers with integrated sensing and communication applications based on 5G systems (5GS), including the management and control of 5G-based sensing services. For example, it is for infrastructure-assisted environmental sensing, infrastructure-based remote control driving, high-definition map collection and sharing, and remote control driving support.

Examples of communication-assisted sensing services provided by 5GS may include the following instances.

Real-time environmental monitoring: reconstructing environmental maps using wireless signals to further improve positioning accuracy and enable environmental related applications, such as implementing a series of real-time monitoring related applications, including dynamic 3D maps for assisted driving, pedestrian flow statistics, intrusion detection, traffic detection, etc.

Autonomous vehicles/drones: autonomous vehicles/drone applications have some common functional requirement. For example, autonomous vehicles/drones should support detection and avoidance (DAA) to avoid obstacles. At the same time, autonomous vehicles/drones should have the capability to monitor path information, such as selecting routes and complying with traffic rules.

Air pollution monitoring: the quality of the received wireless signal shows different attenuation characteristics with changes in air humidity, air particulate matter (PM) concentration, carrier frequency, etc., which may be used for weather or air quality detection.

Indoor health care and intrusion detection: this may be used to realize breathing rate estimation, breathing depth estimation, apnea detection, vital sign monitoring of the elderly, and indoor intrusion detection.

Sensing of wireless communication channels and environment could further improve the performance of communication systems. Some examples of sensing assisted communication scenarios may include:

Sensing UE's location and channel environment to narrow the beam sweeping range and shorten the beam training time.

Sensing UE's location, velocity, motion trajectory, and channel environment for beam prediction, and reducing the overhead of beam measurement and the delay of beam tracking.

Sensing UE's property and channel environment to improve the performance of channel estimation.

In a core network side, the sensing service is provided by a Sensing Application Function (SAF). The sensing service function may be deployed on a sensing server. Different sensing service functions may be deployed on the same or different sensing servers. UE requires different sensing service functions to access when UE moves and performs different types of sensing processing. Thus, how the UE dynamically acquires service information of the sensing application function (such as an address of the sensing server, etc.) to acquire the sensing service is an urgent problem to be solved.

As shown in FIG. 2, an embodiment of the present disclosure provides a method for processing information, performed by an AMF, including steps 201-202:

in step 201: request information sent by a UE is received, where the request information is configured to request service information of a sensing application function;

in step 202: based on the request information, the service information of the sensing application function is sent to the UE, where the service information is at least configured to indicate an address of the sensing application function.

The sensing application function may be used to provide the sensing service to the UE. Here, the sensing service includes but is not limited to a sensing service based on a communication signal, such as environmental sensing based on the communication signal.

In an embodiment, the service information includes location information of the sensing application function, such as an IP address. The sensing application function may be deployed within the sensing application server. The UE may access the sensing application function based on the service information and/or register with the sensing application function. The service information also includes access information of the sensing application function. The access information may include information required by the UE for sensing through the sensing application function. The access information may include but is not limited to: access authentication information of the sensing application function, type information of the sensing application function, and the like.

The sensing application function deployed in the core network may change, that is, the sensing application function that may be accessed by the UE may change; and/or during the movement of the UE, the sensing application function that may be accessed by the UE may change; and/or different sensing service requirements require access to different sensing application functions. Thus, the UE needs to dynamically acquire the service information of the sensing application function.

The UE may send the request information to the AMF, requesting the service information of the sensing application function. The request information may be an indicator that requests the service information of the sensing application function from the AMF. The request information may also include associated information of the sensing application function requested, limiting the requested sensing application function. For example, the request information may include type information of the sensing application function, etc., configured to indicate a type of the sensing application function requested.

The request information may also be implicitly indicated by capability information of the UE, the UE may report its sensing capability to the AMF, and when the AMF determines that the UE has the sensing capability, the AMF may send the service information of the sensing application function of the core network to the UE.

The request information may be carried in an uplink Non Access Stratum (NAS) message and forwarded by an access network device to the AMF. Here, the access network device may include: a base station.

The request information may be specific to a particular sensing application function, for example, the request information may include type indication information of the requested sensing application function. The request information may also be specific to all of the sensing application functions, and is configured to request all of the sensing application functions available to the UE.

After acquiring the request information, the AMF may send the service information of the sensing application function to the UE. The service information of the sensing application function may be determined based on the request information. The AMF may send service information of a specified type of the sensing application function to the UE according to the indication of the request information. The AMF may send the service information of the sensing application function currently available to the UE according to the indication of the request information.

The service information of the sensing application function may be carried in a downlink NAS message and forwarded by the access network device to the UE. The service information of the UE's sensing application function sent may be service information of one or more sensing application functions.

In an embodiment, the service information is pre-stored in the AMF.

The service information of the sensing application function may be pre-stored in the core network, for example, the service information of the sensing application function may be pre-stored in network elements such as the AMF and the SMF. The AMF may acquire the stored service information of the sensing application function and/or acquire the service information of the sensing application function from other network elements in the core network, and send it to the UE. For example, the AMF may acquire the service information of the sensing application function from the SMF.

In this way, by sending the request information from the UE to the AMF, the AMF, in response to the request information, sends the service information of the sensing application function to the UE, such that the UE dynamically acquires the service information of the sensing application function, thereby improving the flexibility of the UE in acquiring the service information of the sensing application function.

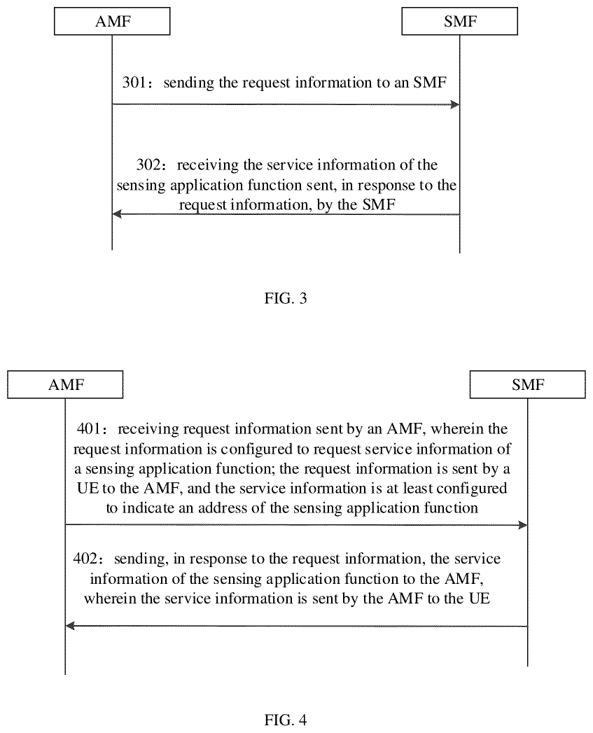

As shown in FIG. 3, an embodiment of the present disclosure provides a method for processing information, performed by the AMF, including steps 301-302:

in step 301: the request information is sent to an SMF;

in step 302: the service information of the sensing application function that is sent, in response to the request information, by the SMF is received.

The steps 301 and 302 may be implemented separately or in combination with steps 201 and 202.

The service information of the sensing application function sent by the AMF to the UE may be received from the SMF. The AMF may send the request information to the SMF, and the SMF sends the service information of the sensing application function to the AMF.

In an embodiment, the SMF may send the service information of the sensing application function requested in the request information to the AMF based on the indication of the request information.

In an embodiment,

the service information is pre-stored in the SMF;

or,

the service information is acquired by the SMF from a Policy Control Function PCF.

The service information may be pre-stored in the SMF. The service information may also be pre-stored in the PCF. The SMF may receive the service information of the sensing application function from the PCF.

In an embodiment, the SMF may send the request information to the PCF and receive the service information of the sensing application function that is sent by the PCF to the SMF based on the request information.

In an embodiment, the receiving the request information sent by the user equipment UE includes:

receiving a packet data unit (PDU) session establishment request message carrying the request information;

the sending the service information of the sensing application function to the UE includes:

sending PDU session response information carrying the service information to the UE, where the PDU session response information is associated with an acceptance of establishment of a PDU session.

The UE may request the service information of the sensing application function from the core network during the establishment of the PDU session.

During the establishment of the PDU session, the UE may send a PDU Session Establishment Request message (PDU Session Establishment Request) to the AMF. The UE may carry the request message in the PDU session establishment request message.

In an embodiment, the request information includes at least one of the following:

request information carried in a Session Management (SM) container of the PDU session establishment request message; or

sensing capability information of the UE carried in a Protocol Configuration Option (PCO) of the PDU session establishment request message.

The UE may set the request information in the SM container of the PDU session establishment request. Here, the SM container may be an N1 SM container.

For example, the request information may be an indicator of an IP address (SAF IP address) of the sensing application function requested by the UE.

The UE carrying the sensing application function may indicate its capability to support the sensing application function in the PCO.

The request information may also be implicitly indicated by the sensing capability information of the UE. The UE may report its own sensing capability information to the AMF. When the AMF determines that the UE has the sensing capability, the AMF may send the service information of the sensing application function of the core network to the UE.

For example, the request information may be the sensing capability information of the UE, and the UE may set the sensing capability information in the PCO of the PDU session establishment request. The AMF may send the service information of the sensing application function to the UE based on the sensing capability of the UE.

The AMF may carry the service information of the sensing application function in the PDU session response information associated with the acceptance of the establishment of the PDU session.

The PDU session response information may be information that the core network sends to the UE through the AMF after receiving the PDU session establishment request.

In an embodiment, the sending the PDU session response information carrying the service information to the UE includes:

sending an N2 PDU session request carrying a Non Access Stratum (NAS) message to an access network device, where the NAS message carries the service information, and the NAS message is sent by the access network device to the UE.

After the core network receives the PDU session establishment request, the AMF may send the N2 PDU session request to the access network device (such as the base station). The N2 PDU session request may include NAS information sent to the UE. The access network device may carry the service information of the sensing application function within the NAS information and send it to the UE.

In an embodiment, the service information is carried in the SM container of the PDU session response information and/or in the PCO of the PDU session response information.

For example, in response to the request information being within the SM container, the AMF may carry the service information within the SM container and send it to the UE. In response to the request information being within the PCO, the AMF may carry the service information within the PCO and send it to the UE.

In an embodiment,

the sending the request information to the session management function SMF includes:

sending a PDU session context request carrying the request information to the SMF;

the receiving the service information of the sensing application function that is sent, in response to the request information, by the SMF includes:

receiving N1N2 message transfer carrying the service information that is sent, in response to the PDU session context request, by the SMF.

During the establishment of the PDU session, the UE may send the PDU Session Establishment Request message (PDU Session Establishment Request) to the AMF. The UE may carry the request message in the PDU session establishment request message. The AMF may send a PDU session context request (Nsmf_PDUSession_CreateSMContext) to the SMF, where the PDU session context request may be carried with the request information.

In an embodiment, the request information carried by the PDU session context request may be an indicator configured to request the service information of the sensing application function. In some embodiments, the request information carried by the PDU session context request may also include the sensing capability information of the UE carried in the protocol configuration option PCO of the PDU session context request.

After receiving the PDU Session Establishment Request message (PDU Session Establishment Request), the SMF may respond by sending the PDU Session Establishment Response message (PDU Session Establishment Response) to the AMF, and send an SM Policy Association Establishment request to the PCF. The SM policy association establishment request may be carried with the request information and request the service information of the sensing application function from the PCF.

The PCF may carry the service information of the sensing application function in the response information that is sent to the SMF in response to the SM policy association establishment request.

The SMF may send an N4 session establishment request to a User Plane Function (UPF) to establish a new PDU session for the UE.

After the SMF determines the establishment of the N4 session, the SMF may send N1N2 message transfer (such as Namf_Communication_N1N2Message Transfer) to the AMF, and carry the acquired service information of the sensing application function in the N1N2 message transfer.

In an embodiment, the service information is carried in the SM container of the N1N2 message transfer and/or in the PCO for N1N2 message transfer.

In an embodiment, the service information of the sensing application function carried in the N1N2 message transfer may be pre-stored in the SMF and/or received by the SMF from the PCF.

After receiving the service information of the sensing application function in the N1N2message transfer, the AMF may carry the service information of the sensing application function in the NAS message of the N2 PDU session request and send it to the access network device, and the access network device sends the NAS message to the UE, such that the UE may acquire the service information of the sensing application function.

In an embodiment, the receiving the request information sent by the user equipment UE includes:

receiving a registration request message carrying the request information;

The sending the service information of the sensing application function to the UE includes:

sending a registration accept message carrying the service information to the UE.

The UE may request the service information of the sensing application function from the core network during the process of registering to the cellular mobile communication network.

During the registration process, the UE may send a Registration Request message (Registration Request) to the AMF. The UE may carry the request information in the registration request message.

For example, the request information may be an indicator of an IP address (SAF IP address) of the sensing application function requested by the UE.

The request information may also be implicitly indicated by the sensing capability information of the UE. The UE may report its own sensing capability information to the AMF. When the AMF determines that the UE has the sensing capability, the AMF may send the service information of the sensing application function of the core network to the UE.

For example, the request information may be the sensing capability information of the UE, and the UE may set the sensing capability information in the registration request message. The AMF may send the service information of the sensing application function to the UE based on the sensing capability of the UE.

The AMF may carry the service information of the sensing application function in the Registration Accept message (Registration Accept). The UE may acquire the service information of the sensing application function from the registration accept message.

In an embodiment, the service information may be pre-stored in the AMF. The AMF may carry the service information of the sensing application function that is pre-stored in the AMF in the registration accept message and send it to the UE.

In an embodiment, the request information is sent to the policy control function PCF;

the service information sent by the PCF in response to the request information is received, where the service information is pre-stored in the PCF.

The service information may be pre-stored in the AMF. The service information may also be pre-stored in the PCF. The AMF may receive the service information of the sensing application function from the PCF.

In an embodiment, the AMF may send the request information to the PCF and receive the service information of the sensing application function that is sent, based on the request information, by the PCF to the AMF. The service information may be pre-stored in the PCF.

In an embodiment, the sending the request information to the PCF includes:

sending an access management AM policy association establishment message carrying the request information to the PCF.

During the process of the UE registering to the cellular mobile communication network, after receiving the registration request message, the AMF may send an AM policy association establishment message to the PCF, and the AMF may carry the request information in the AM policy association establishment message. The PCF may send the service information of the sensing application function to the AMF based on the request information. For example, the PCF may send address information of the sensing application function, such as an IPR address, to the AMF.

As shown in FIG. 4, an embodiment of the present disclosure provides a method for processing information performed by an SMF, including steps 401-402:

in step 401: request information sent by an AMF is received, where the request information is configured to request service information of a sensing application function; the request information is sent by a UE to the AMF, and the service information is at least configured to indicate an address of the sensing application function;

in step 402: in response to the request information, the service information of the sensing application function is sent to the AMF, where the service information is sent by the AMF to the UE.

The sensing application function may be used to provide the sensing service to the UE. Here, the sensing service includes but is not limited to the sensing service based on the communication signal, such as the environmental sensing based on the communication signal.

In an embodiment, the service information includes location information of the sensing application function, such as an IP address. The sensing application function may be deployed within the sensing application server. The UE may access the sensing application function based on the service information. The service information also includes access information of the sensing application function. The access information may include information required by the UE for sensing through the sensing application function. The access information may include but is not limited to: access authentication information of the sensing application function, type information of the sensing application function, and the like.

The sensing application function deployed in the core network may change, that is, the sensing application function that may be accessed by the UE may change; and/or during the movement of the UE, the sensing application function that may be accessed by the UE may change; and/or different sensing service requirements require access to different sensing application functions. Thus, the UE needs to dynamically acquire the service information of the sensing application function.

The UE may send the request information to the AMF, requesting the service information of the sensing application function. The request information may be an indicator that requests the service information of the sensing application function from the AMF. The request information may also include associated information of the sensing application function requested, limiting the requested sensing application function. For example, the request information may include type information of the sensing application function, etc., configured to indicate a type of the sensing application function requested.

The request information may also be implicitly indicated by capability information of the UE, the UE may report its sensing capability to the AMF, and when the AMF determines that the UE has the sensing capability, the AMF may send the service information of the sensing application function of the core network to the UE.

The request information may be carried in an uplink NAS message and forwarded by an access network device to the AMF. Here, the access network device may include: a base station.

The request information may be specific to a particular sensing application function, for example, the request information may include type indication information of the requested sensing application function. The request information may also be specific to all of the sensing application functions, and is configured to request all of the sensing application functions available to the UE.

After acquiring the request information, the AMF may send the service information of the sensing application function to the UE. The service information of the sensing application function may be determined based on the request information. The AMF may send service information of a specified type of the sensing application function to the UE according to the indication of the request information. The AMF may send the service information of the sensing application function currently available to the UE according to the indication of the request information.

The service information of the sensing application function may be carried in a downlink NAS message and forwarded by the access network device to the UE. The service information of the UE's sensing application function sent may be service information of one or more sensing application functions.

In an embodiment, the service information is pre-stored in the AMF.

The service information of the sensing application function may be pre-stored in the core network, for example, the service information of the sensing application function may be pre-stored in network elements such as the AMF and the SMF. The AMF may acquire the stored service information of the sensing application function and/or acquire the service information of the sensing application function from other network elements in the core network, and send it to the UE. For example, the AMF may acquire the service information of the sensing application function from the SMF.

The service information of the sensing application function that is sent by the AMF to the UE may be received from the SMF. The SMF receives the request information sent by the AMF and sends the service information of the sensing application function to the AMF.

In an embodiment, the SMF may send the service information of the sensing application function requested in the request information to the AMF based on the indication of the request information.

In this way, by sending the request information from the UE to the AMF, the AMF requests the service information of the sensing application function from the SMF, and sends the service information of the sensing application function to the UE through the AMF. Thus, the UE dynamically acquires the service information of the sensing application function, thereby improving the flexibility of the UE in acquiring the service information of the sensing application function.

In an embodiment, the receiving the request information sent by the AMF includes:

receiving a packet data unit PDU session context request carrying the request information.

During the establishment of the PDU session, the UE may send a PDU Session Establishment Request message (PDU Session Establishment Request) to the AMF. The UE may carry the request message in the PDU session establishment request message.

The SMF receives the PDU session context request (Nsmf_PDUSession_CreateSMContext) that is sent by the AMF in response to the PDU session establishment request message to the SMF, and the PDU session context request may include the request information.

In an embodiment, the request information includes at least one of the following:

request information carried in a Session Management SM container of the PDU session context request; or

sensing capability information of the UE carried in a Protocol Configuration Option PCO of the PDU session context request.

In an embodiment, the request information carried by the PDU session context request may be an indicator configured to request the service information of the sensing application function. In some embodiments, the request information carried by the PDU session context request may also include the sensing capability information of the UE carried in the protocol configuration option PCO.

In an embodiment, the service information is pre-stored in the SMF.

The SMF may send the service information of the sensing application function to the AMF in response to the received request information. The service information of the sensing application function may be pre-stored in the SMF.

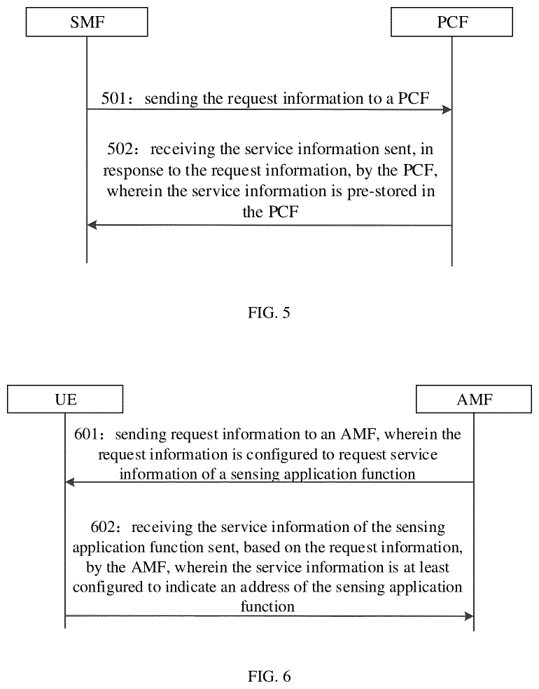

As shown in FIG. 5, an embodiment of the present disclosure provides a method for processing information, performed by an SMF, including steps 501-502:

in step 501: the request information is sent to a PCF;

in step 502: the service information sent by the PCF in response to the request information is received, where the service information is pre-stored in the PCF.

The steps 501 and 502 may be implemented separately or in combination with steps 401 and 402.

The service information may be pre-stored in the SMF. The service information may also be pre-stored in the PCF. The SMF may receive the service information of the sensing application function from the PCF.

In an embodiment, the SMF may send the request information to the PCF and receive the service information of the sensing application function that is sent by the PCF to the SMF based on the request information. The service information may be pre-stored in PCF.

In an embodiment, the sending the request information to the PCF includes:

sending a Session Management SM policy management establishment request carrying the request information to the PCF.

After receiving the PDU Session Establishment Request message (PDU Session Establishment Request), the SMF may respond by sending the PDU Session Establishment Response message (PDU Session Establishment Response) to the AMF, and send an SM Policy Association Establishment request to the PCF. The SM policy association establishment request may be carried with the request information and request the service information of the sensing application function from the PCF.

In an embodiment, the sending the service information of the sensing application function to the AMF includes:

sending N1N2 message transfer carrying the service information to the AMF.

In the process of establishing the PDU session, the PCF may carry the service information of the sensing application function in the response information that is sent to the SMF in response to the SM policy association establishment request.

The SMF may send an N4 session establishment request to the UPF to establish a new PDU session for the UE;

After the SMF determines the establishment of the N4 session, the SMF may send N1N2 message transfer (such as Namf_Communication_N1N2Message Transfer) to the AMF, and carry the acquired service information of the sensing application function in the N1N2message transfer.

In an embodiment, the service information is carried in the SM container of the N1N2 message transfer and/or in the PCO for N1N2 message transfer.

In an embodiment, the service information of the sensing application function carried in the N1N2 message transfer may be pre-stored in the SMF and/or received by the SMF from the PCF.

After receiving the service information of the sensing application function in the N1N2message transfer, the AMF may carry the service information of the sensing application function in the NAS message of the N2 PDU session request and send it to the access network device, and the access network device sends the NAS message to the UE, such that the UE may acquire the service information of the sensing application function.

As shown in FIG. 6, an embodiment of the present disclosure provides a method for processing information, performed by a UE, including steps 601-602:

in step 601: request information is sent to an AMF, where the request information is configured to request service information of a sensing application function;

in step 602: the service information of the sensing application function that is sent by the AMF based on the request information is received, where the service information is at least configured to indicate an address of the sensing application function.

The sensing application function may be used to provide the sensing service to the UE. Here, the sensing service includes but is not limited to a sensing service based on a communication signal, such as environmental sensing based on the communication signal.

In an embodiment, the service information includes location information of the sensing application function, such as an IP address. The sensing application function may be deployed within the sensing application server. The UE may access the sensing application function based on the service information. The service information also includes access information of the sensing application function. The access information may include information required by the UE for sensing through the sensing application function. The access information may include but is not limited to: access authentication information of the sensing application function, type information of the sensing application function, and the like.

The sensing application function deployed in the core network may change, that is, the sensing application function that may be accessed by the UE may change; and/or during the movement of the UE, the sensing application function that may be accessed by the UE may change; and/or different sensing service requirements require access to different sensing application functions. Thus, the UE needs to dynamically acquire the service information of the sensing application function.

The UE may send the request information to the AMF, requesting the service information of the sensing application function. The request information may be an indicator that requests the service information of the sensing application function from the AMF. The request information may also include associated information of the sensing application function requested, limiting the requested sensing application function. For example, the request information may include type information of the sensing application function, etc., configured to indicate a type of the sensing application function requested.

The request information may also be implicitly indicated by capability information of the UE, the UE may report its sensing capability to the AMF, and when the AMF determines that the UE has the sensing capability, the AMF may send the service information of the sensing application function of the core network to the UE.

The request information may be carried in an uplink NAS message and forwarded by an access network device to the AMF. Here, the access network device may include: a base station.

The request information may be specific to a particular sensing application function, for example, the request information may include type indication information of the requested sensing application function. The request information may also be specific to all of the sensing application functions, and is configured to request all of the sensing application functions available to the UE.

After acquiring the request information, the AMF may send the service information of the sensing application function to the UE. The service information of the sensing application function may be determined based on the request information. The AMF may send service information of a specified type of the sensing application function to the UE according to the indication of the request information. The AMF may send the service information of the sensing application function currently available to the UE according to the indication of the request information.

The service information of the sensing application function may be carried in a downlink NAS message and forwarded by the access network device to the UE. The service information of the UE's sensing application function sent may be service information of one or more sensing application functions.

In an embodiment, the service information is pre-stored in the AMF.

The service information of the sensing application function may be pre-stored in the core network, for example, the service information of the sensing application function may be pre-stored in network elements such as the AMF and the SMF. The AMF may acquire the stored service information of the sensing application function and/or acquire the service information of the sensing application function from other network elements in the core network, and send it to the UE. For example, the AMF may acquire the service information of the sensing application function from the SMF.

The service information of the sensing application function sent by the AMF to the UE may be received from the SMF. The AMF may send the request information to the SMF, and the SMF sends the service information of the sensing application function to the AMF.

In an embodiment, the SMF may send the service information of the sensing application function requested in the request information to the AMF based on the indication of the request information.

In an embodiment,

the service information is pre-stored in the SMF;

or,

the service information is acquired by the SMF from a Policy Control Function PCF.

The service information may be pre-stored in the SMF. The service information may also be pre-stored in the PCF. The SMF may receive the service information of the sensing application function from the PCF.

In an embodiment, the SMF may send the request information to the PCF and receive the service information of the sensing application function that is sent by the PCF to the SMF based on the request information.

In this way, by sending the request information from the UE to the AMF, the AMF, in response to the request information, sends the service information of the sensing application function to the UE, such that the UE dynamically acquires the service information of the sensing application function, thereby improving the flexibility of the UE in acquiring the service information of the sensing application function.

In an embodiment, the sending the request information to the AMF includes:

sending a Packet Data Unit PDU session establishment request message carrying the request information to the AMF;

the receiving the service information of the sensing application function sent, based on the request information, by the AMF includes:

receiving PDU session response information carrying the service information, where the PDU session response information is associated with an acceptance of establishment of a PDU session.

The UE may request the service information of the sensing application function from the core network during the establishment of the PDU session.

During the establishment of the PDU session, the UE may send a PDU Session Establishment Request message (PDU Session Establishment Request) to the AMF. The UE may carry the request message in the PDU session establishment request message.

In an embodiment, the request information includes at least one of the following:

request information carried in a Session Management SM container of the PDU session establishment request message; or

sensing capability information of the UE carried in a Protocol Configuration Option PCO of the PDU session establishment request message.

The UE may set the request information in the SM container of the PDU session establishment request message. Here, the SM container may be an N1 SM container.

For example, the request information may be an indicator of an IP address (SAF IP address) of the sensing application function requested by the UE.

The UE carrying the sensing application function may indicate its capability to support the sensing application function in the PCO.

The request information may also be implicitly indicated by the sensing capability information of the UE. The UE may report its own sensing capability information to the AMF. When the AMF determines that the UE has the sensing capability, the AMF may send the service information of the sensing application function of the core network to the UE.

For example, the request information may be the sensing capability information of the UE, and the UE may set the sensing capability information in the PCO of the PDU session establishment request message. The AMF may send the service information of the sensing application function to the UE based on the sensing capability of the UE.

The AMF may carry the service information of the sensing application function in the PDU session response information associated with the acceptance of the establishment of the PDU session.

The PDU session response information may be information that the core network sends to the UE through the AMF after receiving the PDU session establishment request.

In an embodiment, the receiving the PDU session response information carrying the service information includes:

receiving an NAS message carrying the service information sent by an access network device, where the NAS message is carried in an N2 PDU session request sent by the AMF to the access network device.

After the core network receives the PDU session establishment request, the AMF may send the N2 PDU session request to the access network device (such as the base station). The N2 PDU session request may include NAS information sent to the UE. The access network device may carry the service information of the sensing application function within the NAS information and send it to the UE.

In an embodiment, the service information is carried in the SM container of the PDU session response information and/or in the PCO of the PDU session response information.

For example, in response to the request information being within the SM container, the AMF may carry the service information within the SM container and send it to the UE. In response to the request information being within the PCO, the AMF may carry the service information within the PCO and send it to the UE.

In an embodiment,

the AMF sends a PDU session context request carrying the request information to the SMF;

The AMF receives N1N2 message transfer carrying the service information that is sent, in response to the PDU session context request, by the SMF.

During the establishment of the PDU session, the UE may send the PDU Session Establishment Request message (PDU Session Establishment Request) to the AMF. The UE may carry the request message in the PDU session establishment request message. The AMF may send a PDU session context request (Nsmf_PDUSession_CreateSMContext) to the SMF, where the PDU session context request may be carried with the request information.

In an embodiment, the request information carried by the PDU session context request may be an indicator configured to request the service information of the sensing application function. In some embodiments, the request information carried by the PDU session context request may also include the sensing capability information of the UE carried in the protocol configuration option PCO.

After receiving the PDU Session Establishment Request message (PDU Session Establishment Request), the SMF may respond by sending the PDU Session Establishment Response message (PDU Session Establishment Response) to the AMF, and send an SM Policy Association Establishment request to the PCF. The SM policy association establishment request may be carried with the request information and request the service information of the sensing application function from the PCF.

The PCF may carry the service information of the sensing application function in the response information that is sent to the SMF in response to the SM policy association establishment request.

The SMF may send an N4 session establishment request to a UPF to establish a new PDU session for the UE.

After the SMF determines the establishment of the N4 session, the SMF may send N1N2 message transfer (such as Namf_Communication_N1N2Message Transfer) to the AMF, and carry the acquired service information of the sensing application function in the N1N2 message transfer.

In an embodiment, the service information is carried in the SM container of the N1N2 message transfer and/or in the PCO for N1N2 message transfer.

In an embodiment, the service information of the sensing application function carried in the N1N2 message transfer may be pre-stored in the SMF and/or received by the SMF from the PCF.

After receiving the service information of the sensing application function in the N1N2 message transfer, the AMF may carry the service information of the sensing application function in the NAS message of the N2 PDU session request and send it to the access network device, and the access network device sends the NAS message to the UE, such that the UE may acquire the service information of the sensing application function.

In an embodiment, the sending the request information to the AMF includes:

sending a registration request message carrying the request information to the AMF;

the receiving the service information of the sensing application function that is sent by the AMF based on the request information includes:

receiving a registration accept message carrying the service information.

The UE may request the service information of the sensing application function from the core network during the process of registering to the cellular mobile communication network.

During the registration process, the UE may send a Registration Request message (Registration Request) to the AMF. The UE may carry the request information in the registration request message.

For example, the request information may be an indicator of an IP address (SAF IP address) of the sensing application function requested by the UE.

The request information may also be implicitly indicated by the sensing capability information of the UE. The UE may report its own sensing capability information to the AMF. When the AMF determines that the UE has the sensing capability, the AMF may send the service information of the sensing application function of the core network to the UE.

For example, the request information may be the sensing capability information of the UE, and the UE may set the sensing capability information in the registration request message. The AMF may send the service information of the sensing application function to the UE based on the sensing capability of the UE.

The AMF may carry the service information of the sensing application function in the Registration Accept message (Registration Accept). The UE may acquire the service information of the sensing application function from the registration accept message.

In an embodiment, the service information may be pre-stored in the AMF. The AMF may carry the service information of the sensing application function that is pre-stored in the AMF in the registration accept message and send it to the UE.

In an embodiment, the AMF sends the request information to the policy control function PCF;

The AMF receives the service information that is sent by the PCF in response to the request information, where the service information is pre-stored in the PCF.

The service information may be pre-stored in the AMF. The service information may also be pre-stored in the PCF. The AMF may receive the service information of the sensing application function from the PCF.

In an embodiment, the AMF may send the request information to the PCF and receive the service information of the sensing application function that is sent, based on the request information, by the PCF to the AMF. The service information may be pre-stored in the PCF.

In an embodiment, the AMF sending the request information to the PCF includes:

sending, by the AMF, an access management AM policy association establishment message carrying the request information to the PCF.

During the process of the UE registering to the cellular mobile communication network, after receiving the registration request message, the AMF may send an AM policy association establishment message to the PCF, and the AMF may carry the request information in the AM policy association establishment message. The PCF may send the service information of the sensing application function to the AMF based on the request information. For example, the PCF may send address information of the sensing application function, such as an IPR address, to the AMF.

To further explain any embodiments disclosed herein, several specific embodiments are provided below.

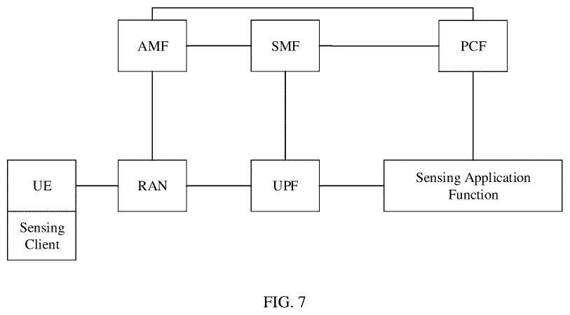

A core network architecture with the sensing application function is shown in FIG. 7.

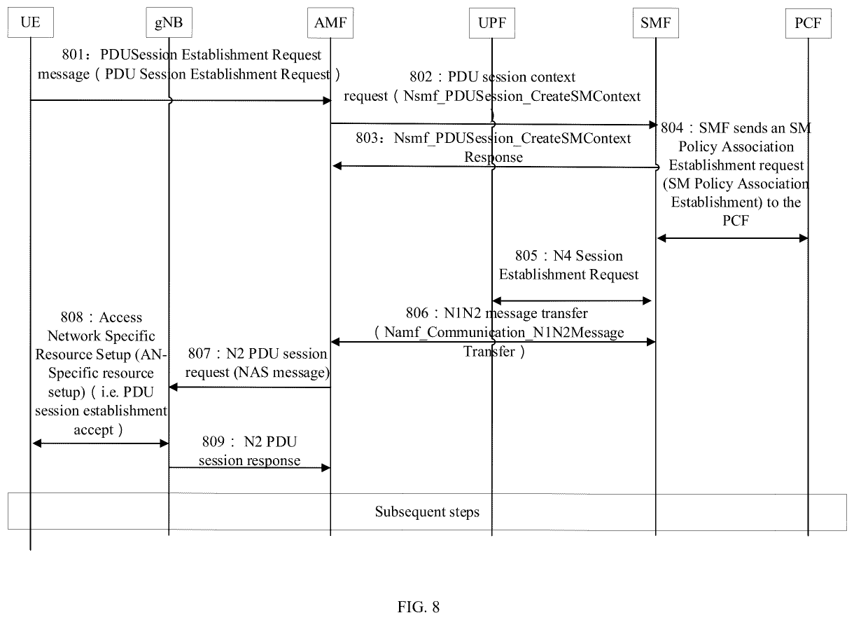

Specific steps for the UE to request the service information of the sensing application function during the request to establish the PDU session are shown in FIG. 8, including steps 801-809:

in step 801: the UE initiates the PDU session establishment process that is requested by the UE by the transmission of a NAS message. The NAS message includes a PDU Session Establishment Request message (PDU Session Establishment Request). The PDU session establishment request message is included within the N1 SM container. The PDU session establishment request message may include the request information (such as an indicator of the SAF IP address) of the UE in the SM container. The UE carrying the sensing function may indicate its capability to support the sensing function in the PCO. The AMF receives a PDU session establishment request message.

In step 802: the AMF selects an SMF and sends a PDU session context request (Nsmf_PDUSession_CreateSMContext) to the SMF, the PDU session context request may include an indicator that the UE requests the SAF IP address(es) and/or a PCO about the capability of the UE to support the sensing function.

In step 803: the SMF receives Nsmf_PDUSession_CreateSMContext Request and responds to AMF with Nsmf_PDUSession_CreateSMContext Response.

In step 804: the SMF sends an SM Policy Association Establishment request (SM Policy Association Establishment) to the PCF, the PCF may request for the SAF address(es) for the UE; the PCF responds to the SMF with the SAF address(es).

In step 805: the SMF sends an N4 Session Establishment Request to the UPF to establish a new PDU session for the UE.

In step 806: the SMF sends an N1N2 message transfer

(Namf_Communication_N1N2Message Transfer) to the AMF, which includes the SAF address(es) received from the PCF or configured in the SMF, the SAF address(es) may be included in the SM container and/or the PCO.

In step 807: the AMF receives the Namf_Communication_N1N2Message and sends an N2 PDU session request (NAS message) to the gNB, which includes the SAF address in the SM container and/or the PCO.

In step 808: during the Access Network Specific Resource Setup (AN-Specific resource setup) (i.e. PDU session establishment accept), the gNB forwards the NAS message provided in step 807 to the UE, which includes the SAF address(es) in the SM container and/or the PCO.

In step 809: the gNB sends the N2 PDU session response to the AMF.

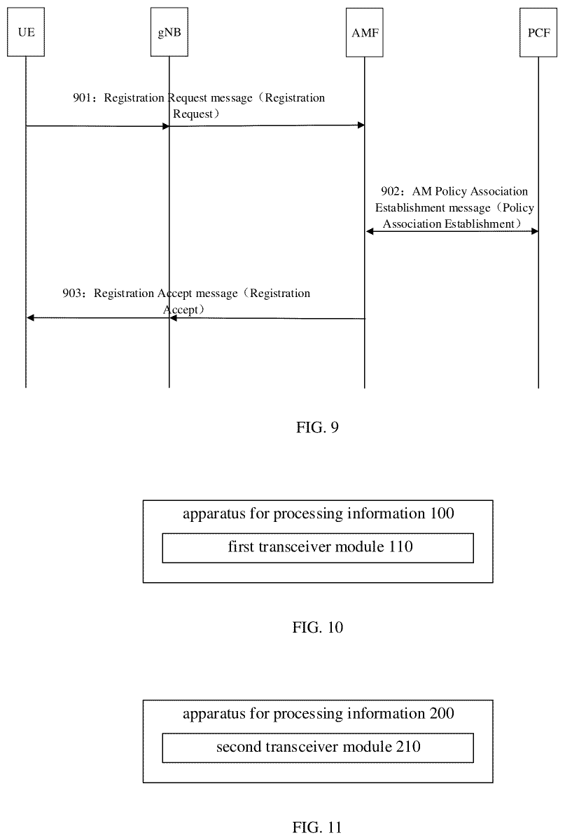

The specific steps for the UE to request the service information of the sensing application function during the process of sending a registration request to the gNB/AMF are shown in FIG. 9, including steps 901-903:

In step 901: the UE sends a Registration Request message (Registration Request) to the gNB/AMF, in addition to the normal parameters such as a registration type, a Subscription Concealed Identifier (SUCI), a Global Unique Temporary UE Identifier (5G-GUTI), or a Permanent Equipment Identifier (PEI), a security parameter, which also includes either a sensing DNN(s) or an indication of requesting sensing service information (i.e. request information).

In step 902: the AMF sends an AM Policy Association Establishment message (Policy Association Establishment) to the PCF, indicating to request SAF information (i.e. SAF service information) for the UE: the PCF may respond to the AMF with the SAF address(es).

In step 903: the AMF responds to the UE with the SAF service information (such as SAF address(es)) carried in the Registration Accept message (Registration Accept), the SAF address may be received from the PCF or configured in the AMF. the UE may register and interact with the SAF based on the received SAF address.

As shown in FIG. 10, an embodiment of the present disclosure provides an apparatus for processing information 100, applied to the AMF, including:

a first transceiver module 110, configured to receive request information sent by a user equipment UE, where the request information is configured to request service information of a sensing application function;

the first transceiver module 110 is further configured to send, based on the request information, the service information of the sensing application function to the UE, where the service information is at least configured to indicate an address of the sensing application function.

In an embodiment, the first transceiver module 110 is further configured to send the request information to a session management function SMF;

the first transceiver module 110 is further configured to receive the service information of the sensing application function that is sent by the SMF in response to the request information.

In an embodiment, the first transceiver module 110 is specifically configured to:

receive a packet data unit PDU session establishment request message carrying the request information;

the first transceiver module 110 is specifically configured to:

send PDU session response information carrying the service information to the UE, where the PDU session response information is associated with an acceptance of establishment of a PDU session.

In an embodiment, the request information includes at least one of the following:

request information carried in a Session Management SM container of the PDU session establishment request message; or

sensing capability information of the UE carried in a Protocol Configuration Option PCO of the PDU session establishment request message.

In an embodiment, the service information is carried in an SM container of the PDU session response information and/or in a PCO of the PDU session response information.

In an embodiment, the first transceiver module 110 is specifically configured to:

send a PDU session context request carrying the request information to the SMF;

the first transceiver module 110 is specifically configured to:

receive N1N2 message transfer carrying the service information that is sent by the SMF in response to the PDU session context request.

In an embodiment, the service information is pre-stored in the SMF;

or,

the service information is acquired by the SMF from a Policy Control Function PCF.

In an embodiment, the first transceiver module 110 is specifically configured to:

send an N2 PDU session request carrying a Non Access Stratum NAS message to an access network device, where the NAS message carries the service information, and where the NAS message is sent by the access network device to the UE.

In an embodiment, the first transceiver module 110 is specifically configured to:

receive a registration request message carrying the request information;

the first transceiver module 110 is specifically configured to:

send a registration accept message carrying the service information to the UE.

In an embodiment, the first transceiver module 110 is further configured to:

send the request information to a policy control function PCF;

receive the service information that is sent by the PCF in response to the request information, where the service information is pre-stored in the PCF.

In an embodiment, the first transceiver module 110 is specifically configured to:

send an Access Management AM policy association establishment message carrying the request information to the PCF.

In an embodiment, the service information is pre-stored in the Access and Mobility Management Function AMF.

As shown in FIG. 11, an embodiment of the present disclosure provides an apparatus for processing information 200, performed by an SMF, including:

a second transceiver module 210, configured to receive request information sent by an Access and Mobility Management Function AMF, where the request information is configured to request service information of a sensing application function; the request information is sent by a user equipment UE to the AMF, and the service information is at least configured to indicate an address of the sensing application function;

the second transceiver module 210 is further configured to send, in response to the request information, the service information of the sensing application function to the AMF, where the service information is sent by the AMF to the UE.

In an embodiment, the second transceiver module 210 is specifically configured to:

receive a packet data unit PDU session context request carrying the request information.

In an embodiment, the request information includes at least one of the following:

request information carried in a Session Management SM container of the PDU session context request; or

sensing capability information of the UE carried in a Protocol Configuration Option PCO of the PDU session context request.

In an embodiment, the service information is pre-stored in the session management function SMF.

In an embodiment, the second transceiver module 210 is further configured to:

send the request information to the policy control function PCF;

receive the service information that is sent by the PCF in response to the request information, where the service information is pre-stored in the PCF.

In an embodiment, the second transceiver module 210 is specifically configured to:

send a session management SM policy management establishment request carrying the request information to the PCF.

In an embodiment, the second transceiver module 210 is further configured to:

send N1N2 message transfer carrying the service information to the AMF.

In an embodiment, the service information is carried in an SM container for the N1N2 message transfer and/or in a PCO for the N1N2 message transfer.

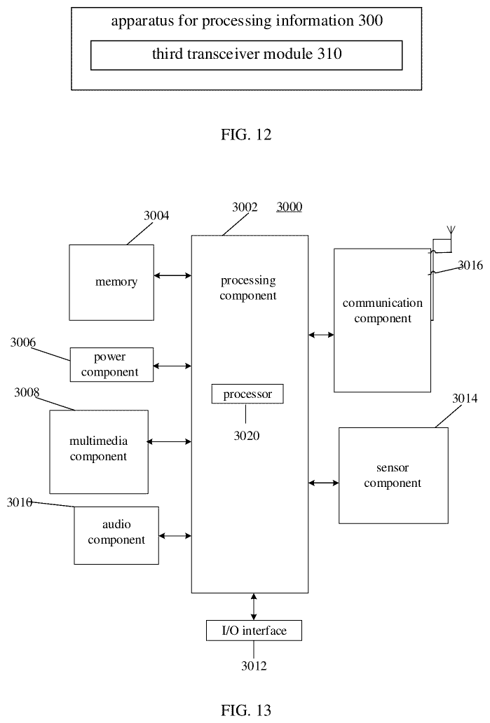

As shown in FIG. 12, an embodiment of the present disclosure provides an apparatus for processing information 300, performed by a UE, including:

a third transceiver module 310, configured to send request information to an access and mobility management function AMF, where the request information is configured to request service information of the sensing application function;

the third transceiver module 310 is further configured to receive the service information of the sensing application function that is sent, based on the request information, by the AMF, where the service information is at least configured to indicate an address of the sensing application function.

In an embodiment, the third transceiver module 310 is specifically configured to:

send a packet data unit PDU session establishment request message carrying the request information to the AMF;

The third transceiver module 310 is specifically configured to:

receive PDU session response information carrying the service information, where the PDU session response information is associated with an acceptance of establishment of a PDU session.

In an embodiment, the request information includes at least one of the following:

request information carried in a Session Management SM container of the PDU session establishment request message; or

sensing capability information of the user equipment UE carried in a Protocol Configuration Option PCO of the PDU session establishment request message.

In an embodiment, the service information is carried in an SM container of the PDU session response information and/or in a PCO of the PDU session response information.

In an embodiment, the third transceiver module 310 is specifically configured to:

receive an NAS message carrying the service information sent by an access network device, where the NAS message is carried in an N2 PDU session request that is sent by the AMF to the access network device.

In an embodiment, the third transceiver module 310 is specifically configured to:

send a registration request message carrying the request information to the AMF;

the third transceiver module 310 is specifically configured to:

receive a registration accept message carrying the service information.

In an embodiment, the service information is pre-stored in the AMF.

It should be noted that those skilled in the art may understand that the apparatuses provided in embodiments of the present disclosure may be executed separately or together with some apparatuses in the embodiments of the present disclosure or related art.

Regarding the apparatus in the above embodiments, the specific ways in which each module performs operations have been described in detail in the embodiments related to the method, and will not be elaborated here.

An embodiment of the present disclosure provides a communication device including:

a processor;

a memory used to store executable instructions of the processor;

the processor is configured to implement the method for processing the information of any embodiment of the present disclosure when running executable instructions.

In an embodiment, the communication device may include, but is not limited to, at least one of the UE and the network device. The network device here may include the core network device or the access network device, etc. Here, the access network device may include the base station; the core network device may include AMF, SMF.

Here, the processor may include various types of storage medium, which are non-temporary computer storage medium that may continue to remember and store information on the user device after power failure.

The processor may be connected to the memory via a bus or other means for reading executable programs stored on the memory, for example, at least one of the methods shown in FIGS. 2 to 6.

The present disclosure also provides a computer storage medium, which stores a computer executable program. When the executable program is executed by a processor, the positioning method of any embodiment of the present disclosure is implemented, for example, at least one of the method for processing the information shown in FIGS. 2 to 6.

Regarding the device or storage medium in the above embodiments, the specific ways in which each module performs operations have been described in detail in the embodiments related to the method, and will not be elaborated here.

FIG. 13 is a block diagram of a user equipment 800 according to an embodiment. For example, the user equipment 800 may be a smartphone, a computer, a digital broadcasting terminal, a massage transmitter/receiver, a tablet device, a game console, a medical device, a fitness device, a personal digital assistant, etc.

Referring to FIG. 13, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the user equipment 800, such as the operations associated with display, telephone calls, data communications, camera operations, and recording operations. The processing component 802 may include one or more processors 820 to execute instructions. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the user equipment 800. Examples of such data include instructions for any applications or methods operated on the user equipment 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the user equipment 800. The power component 806 may include a power management system, one or more power sources, and any other components associated with the generation, management, and distribution of power in the user equipment 800.

The multimedia component 808 includes a screen providing an output interface between the user equipment 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. When the user equipment 800 is in an operation mode, such as a shooting mode or a video mode, the front camera and/or the rear camera may receive external multimedia data. Each front camera and rear camera may be a fixed optical lens system or have focal length and optical zoom capabilities.

The audio component 810 is configured to output and/or input audio signals. For example, the audio component 810 includes a microphone (“MIC”) configured to receive an external audio signal when the user equipment 800 is in an operation mode, such as a call mode, a recording mode, and a voice recognition mode. The received audio signal may be further stored in the memory 804 or transmitted via the communication component 816. In some embodiments, the audio component 810 further includes a speaker for outputting audio signals.

The I/O interface 812 provides an interface between the processing component 802 and peripheral interface modules, such as a keyboard, a click wheel, buttons, and the like. The buttons may include but are not limited to: home button, volume button, start button, and lock button.

The sensor component 814 includes one or more sensors to provide status assessments of various aspects of the user equipment 800. For instance, the sensor component 814 may detect an open/closed status of the user equipment 800, relative positioning of components, e.g., the display and the keypad, of the user equipment 800, a change in position of the user equipment 800 or a component of the user equipment 800, a presence or absence of a target object contact with the user equipment 800, an orientation or an acceleration/deceleration of the user equipment 800, and a change in temperature of the user equipment 800. The sensor assembly 314 may include a proximity sensor configured to detect the presence of nearby objects without any physical contact. The sensor component 814 may also include a light sensor, such as a CMOS or CCD image sensor, applicable for imaging applications. In some embodiments, the sensor component 814 may also include an acceleration sensor, a gyroscope sensor, a magnetic sensor, a pressure sensor or a temperature sensor.

The communication component 816 is configured to facilitate communication, wired or wirelessly, between the user equipment 800 and other devices. The user equipment 800 may access a wireless network based on a communication standard, such as WiFi, 2G, or 3G, or a combination thereof. In one embodiment, the communication component 916 receives a broadcast signal or broadcast associated information from an external broadcast management system via a broadcast channel. In one embodiment, the communication component 816 further includes a near field communication (NFC) module to facilitate short-range communications. For example, the NFC module may be implemented based on a radio frequency identity (RFID) technology, an infrared data association (IrDA) technology, an ultra-wideband (UWB) technology, a Bluetooth (BT) technology, and other technologies.

In embodiments, the user equipment 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, to execute the method according to any of the above embodiments.

In embodiments, there is also provided a non-transitory computer readable storage medium such as a memory 804 storing instructions, which may be executed by a processor 820 of the user equipment 800 to implement the method mentioned above. For example, the non-transitory readable storage medium may be a ROM, a RAM, a CD-ROM, a magnetic tape, a floppy disc, an optical data storage device, and the like.

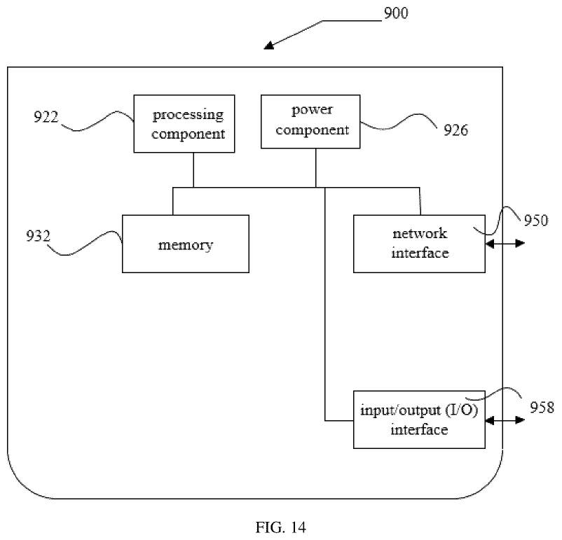

FIG. 14 is a block diagram of a base station according to an embodiment. For example, the base station 900 may be provided as the network device. Referring to FIG. 14, the base station 900 includes a processing component 922 and memory resource represented by a memory 932. The processing component 922 further includes one or more processor. The memory 932 is configured to store instructions executable by the processing component 922, for example, application programs. The application programs stored in the memory 932 may include one or more module each corresponding to a set of instructions. Furthermore, the processing component 922 is configured to execute the instructions, for performing any of the aforementioned methods applied to the base station.

The base station 900 may further include a power component 926 configured to perform power management of the base station 900, a wired or wireless network interface 950 configured to connect the base station 900 to network, and an input/output (I/O) interface 958. The base station 900 may perform based on the operating system stored in the memory 932, for example, Windows Server™, Mac OS X™, Unix™, Linux™, FreeBSD™ or the like.

After considering the specification and practicing the disclosure disclosed herein, those skilled in the art will easily think of other embodiments of the present disclosure. This disclosure is intended to cover any variations, purposes, or adaptive changes of the present disclosure. These variations, purposes, or adaptive changes follow general principles of the present disclosure and include common knowledge or conventional technical means in the technical field not disclosed in the present disclosure. The description and the embodiments are only regarded as exemplary, and the true scope and spirit of the present disclosure are pointed out by the following claims.

It should be understood that the present disclosure is not limited to the precise structure that has been described above and illustrated in the drawings, and various modifications and changes may be made without departing from its scope. The scope of the present disclosure is only limited by the appended claims.

1. A method for processing information, performed by an Access and Mobility Management Function (AMF), comprising:
receiving request information sent by a user equipment (UE), wherein the request information is configured to request service information of a sensing application function; and
sending, based on the request information, the service information of the sensing application function to the UE, wherein the service information is at least configured to indicate an address of the sensing application function.

2. The method according to claim 1, further comprising:
sending the request information to a Session Management Function (SMF); and
receiving the service information of the sensing application function sent, in response to the request information, by the SMF.

3. The method according to claim 1, wherein the receiving the request information sent by the UE comprises:
receiving a Packet Data Unit (PDU) session establishment request message carrying the request information;
wherein the sending the service information of the sensing application function to the UE comprises:
sending PDU session response information carrying the service information to the UE, wherein the PDU session response information is associated with an acceptance of establishment of a PDU session.

4. (canceled)

5. (canceled)

6. The method according to claim 2, wherein the sending the request information to the session management function SMF comprises:
sending a PDU session context request carrying the request information to the SMF;
wherein the receiving the service information of the sensing application function sent, in response to the request information, by the SMF comprises:
receiving N1N2 message transfer carrying the service information sent, in response to the PDU session context request, by the SMF;
wherein the service information is pre-stored in the SMF, or acquired by the SMF from a Policy Control Function (PCF).

7. (canceled)

8. The method according to claim 3, wherein the sending the PDU session response information carrying the service information to the UE comprises:
sending an N2 PDU session request carrying a Non Access Stratum (NAS) message to an access network device, wherein the NAS message carries the service information, and is sent by the access network device to the UE.

9. The method according to claim 1, wherein the receiving the request information sent by the UE comprises:
receiving a registration request message carrying the request information;
wherein the sending the service information of the sensing application function to the UE comprises:
sending a registration accept message carrying the service information to the UE.

10. The method according to claim 9, further comprising:
sending the request information to a PCF; and
receiving the service information sent, in response to the request information, by the PCF, wherein the service information is pre-stored in the PCF;
wherein the sending the request information to the PCF comprises:
sending an Access Management (AM) policy association establishment message carrying the request information to the PCF.

11. (canceled)

12. (canceled)

13. A method for processing information, performed by a Session Management Function (SMF), comprising:
receiving request information sent by an Access and Mobility Management Function (AMF), wherein the request information is configured to request service information of a sensing application function; wherein the request information is sent by a user equipment (UE) to the AMF, and the service information is at least configured to indicate an address of the sensing application function; and
sending, in response to the request information, the service information of the sensing application function to the AMF, wherein the service information is sent by the AMF to the UE.

14. The method according to claim 13, wherein the receiving the request information sent by the AMF comprises:
receiving a Packet Data Unit (PDU) session context request carrying the request information.

15. The method according to claim 14, wherein the request information comprises at least one of:
request information carried in a Session Management (SM) container of the PDU session context request; or
sensing capability information of the UE carried in a Protocol Configuration Option (PCO) of the PDU session context request.

16. The method according to claim 13, wherein the service information is pre-stored in the SMF.

17. The method according to claim 13, further comprising:
sending the request information to a Policy Control Function (PCF); and
receiving the service information sent, in response to the request information, by the PCF, wherein the service information is pre-stored in the PCF;
wherein the sending the request information to the PCF comprises:
sending an SM policy management establishment request carrying the request information to the PCF.

18. (canceled)

19. The method according to claim 13, wherein the sending the service information of the sensing application function to the AMF comprises:
sending N1N2 message transfer carrying the service information to the AMF;
wherein the service information is carried in at least one of an SM container of the N1N2 message transfer or a PCO of the N1N2 message transfer.

20. (canceled)

21. A method for processing information, performed by a user equipment (UE), comprising:
sending request information to an Access and Mobility Management Function (AMF), wherein the request information is configured to request service information of a sensing application function; and
receiving the service information of the sensing application function sent, based on the request information, by the AMF, wherein the service information is at least configured to indicate an address of the sensing application function.

22. The method according to claim 21, wherein the sending the request information to the AMF comprises:
sending a Packet Data Unit (PDU) session establishment request message carrying the request information to the AMF;
the receiving the service information of the sensing application function sent, based on the request information, by the AMF comprises:
receiving PDU session response information carrying the service information, wherein the PDU session response information is associated with an acceptance of establishment of a PDU session.

23. The method according to claim 22, wherein the request information comprises at least one of:
request information carried in a Session Management (SM) container of the PDU session establishment request message; or
sensing capability information of the UE carried in a Protocol Configuration Option (PCO) of the PDU session establishment request message.

24. The method according to claim 22, wherein the service information is carried in at least one of an SM container of the PDU session response information or a PCO of the PDU session response information.

25. The method according to claim 22, wherein the receiving the PDU session response information carrying the service information comprises:
receiving a Non Access Stratum (NAS) message carrying the service information sent by an access network device, wherein the NAS message is carried in an N2 PDU session request sent by the AMF to the access network device.

26. The method according to claim 21, wherein the sending the request information to the AMF comprises:
sending a registration request message carrying the request information to the AMF;
the receiving the service information of the sensing application function sent, based on the request information, by the AMF comprises:
receiving a registration accept message carrying the service information.

27.-36. (canceled)

37. A communication device, comprising:
a processor; and
a memory for storing executable instructions of the processor;
wherein the processor is configured to perform the method according to claim 21.

38. (canceled)
